(19) United States
(12) Patent Application Publication
(10) Pub. No.: US 2013/0142251 A1
(43) Pub. Date: Jun. 6, 2013

(54) SYNTAX EXTENSION OF ADAPTIVE LOOP FILTER IN HEVC

(71) Applicant: Ehsan Maani, San Jose, CA (US)

(72) Inventor: Ehsan Maani, San Jose, CA (US)

(73) Assignee: SONY CORPORATION, Tokyo (JP)

(21) Appl. No.: 13/312,955

(22) Filed: Dec. 6, 2011

(51) Int. Cl. H04N 7/26

(52) U.S. Cl. 375/240.03; 375/240.02; 375/E07.139; 375/E07.126

(57) ABSTRACT

An extension of an adaptive loop filter includes, in the sequence parameter set, a bit is added to signal whether the “default” or fixed adaptive loop filters are to be updated for this sequence. If yes, then the new set of default filters are explicitly coded. In the picture parameter set, a flag is used to determine whether to update the default filters at the picture level. If yes, filter coefficients are transmitted. In the Slice Header, a flag is added to show whether the online filter and the fixed filters are both available for block-level switching or not. Block-level filter switching is also referred to as ALF's CU control parameters. In the LCU Header, the maximum depth (minimum block-size) for the ALF's CU control parameters (block-level filter switchings) is explicitly signaled.

### FIELD OF THE INVENTION

The present invention relates to the field of image processing. More specifically, the present invention relates to an adaptive loop filter.

### BACKGROUND OF THE INVENTION

In the HEVC syntax, either explicit filter coefficients are transmitted at picture-level to be used for filtering or no filtering is used for that particular picture. In other words, current HEVC syntax does not allow including of default filters to be used in the event that the online-trained picture-level filter is not transmitted.

In the HEVC model, Adaptive Loop Filter (ALF) parameters are included only in a Picture Parameter Set (PPS). A 1 bit flag indicates that the ALF is used for the picture. Other parameters such as number of filters and their coefficients follow.

### SUMMARY OF THE INVENTION

An extension of an adaptive loop filter includes, in the sequence parameter set, a bit is added to signal whether the “default” or fixed adaptive loop filters are to be updated for this sequence. If yes, then the new set of default filters are explicitly coded. In the picture parameter set, a flag is used to determine whether to update the default filters at the picture level. If yes, filter coefficients are transmitted. In the Slice Header, a flag is added to show whether the online filter and the fixed filters are both available for block-level switching or not. Block-level filter switching is also referred to as ALF's CU control parameters. In the LCU Header, the maximum depth (minimum block-size) for the ALF's CU control parameters (block-level filter switchings) is explicitly signaled.

In one aspect, a method programmed in a memory of a device comprises determining if fixed filters are flagged to be updated, if the fixed filters are flagged to be updated, then explicitly coding a new set of default filters, determining if the default filters at a picture level are flagged to be updated, if the default filters at the picture level are flagged to be updated, then transmitting filter coefficients, determining if an online filter and fixed filters are flagged as both being available for block-level switching and if the online filter and fixed filters are flagged, then signaling a maximum depth in a largest coding unit header. The method is implemented as part of an adaptive loop filter process. The method is implemented within a high efficiency video coding syntax. The device selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

In another aspect, an apparatus comprises a memory for storing a data structure, the data structure including a sequence parameter set with a default signal bit for signaling whether fixed adaptive loop filters are to be updated for a sequence, a slice header with a block-level flag to indicate whether an online filter and the fixed filters are both available for block-level switching and a large coding unit header for signaling a maximum depth for the fixed filters coding unit control parameters and a processing component coupled to the memory, the processing component configured for processing the application. If the default signal bit is true, then a new set of default filters are explicitly coded. The data structure further comprises a picture parameter set with an update flag to determine whether to update the fixed filters at a picture level. If the update flag is true, then filter coefficients are transmitted. The data structure further comprises an adaptive slice parameter. The adaptive slice parameter is used to determine whether to update the fixed filters at a picture level. The apparatus is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

In another aspect, an encoder comprises a transform and quantization component for applying a transform and quantization to a video, an inverse quantization and transform component for applying an inverse transform and quantization to the video, a deblocking filter for smoothing edges within the video, an adaptive loop filter with a syntax extension for filtering the video and an entropy coder for encoding the video. The adaptive loop filter further comprises a sequence parameter set with a default signal bit for signaling whether fixed adaptive loop filters are to be updated for a sequence. If the default signal bit is true, then a new set of default filters are explicitly coded. The adaptive loop filter further comprises a picture parameter set with an update flag to determine whether to update the fixed filters at a picture level. If the update flag is true, then filter coefficients are transmitted. The adaptive loop filter further comprises a slice header with a block-level flag to indicate whether an online filter and the fixed filters are both available for block-level switching. The adaptive loop filter further comprises a large coding unit header for signaling a maximum depth for the fixed filters coding unit control parameters. The adaptive loop filter further comprises an adaptive slice parameter. The adaptive slice parameter is used to determine whether to update the fixed filters at a picture level. The encoder is implemented in a digital camera or a digital camcorder.

### BRIEF DESCRIPTION OF THE DRAWINGS

FIG. 1 illustrates a diagram of a portion of an encoder including an adaptive loop filter according to some embodiments.

FIG. 2 illustrates a flowchart of a method of implementing the adaptive loop filter with a modified syntax according to some embodiments.

FIG. 3 illustrates a diagram of a modified syntax of HEVC according to some embodiments.

FIG. 4 illustrates a block diagram of an exemplary computing device configured to implement the syntax extension of an adaptive loop filter according to some embodiments.

### DETAILED DESCRIPTION OF THE PREFERRED EMBODIMENT

When encoding a video, a picture is divided into several macroblocks (or coding units). After encoding the macroblocks, the encoder selects an encoding mode according to a desired bit rate and distortion and performs encoding in the selected encoding mode.

A parametric loop filter (also referred to as a parametric adaptive loop filter) uses a set of fixed filters which utilize much less computation, delay and memory access at the encoder than Weiner filters. An example of a parametric loop filter is described in U.S. patent application Ser. No. Atty Docket No. 13/038,182, filed Mar. 1, 2011, and entitled, “PARAMETRIC LOOP FILTER,” which is hereby incorporated by reference. Fixed coefficients allow fast implementation of filtering at the decoder. Each filter is indexed by several parameters (e.g. given a set of parameters, p₁, p₂, . . . , pₙ, the filter is able to be uniquely identified by both encoder and decoder). The parameters that specify the filter of a block are predictive coded and sent to the decoder. The encoder determines the best filter in the set of filters for each block of an image. The selection of the best filter at the encoder is able to be performed in a single pass processing for each large coding unit or block or with multiple passes. In some embodiments, only the parameter (also referred to as an index) of the filter is transmitted to the decoder. In some embodiments, the parameter is uniquely identifiable.

A modified high-level syntax of High Efficiency Video Coding (HEVC) is described herein. HEVC is able to use a set of default filters for in-loop filtering. The filters are able to be updated at different levels such as sequence-level or picture-level. The loop filter is able to implement some or all of the aspects described in U.S. patent application Ser. No. 13/038,051, filed Mar. 1, 2011, titled, “SIMPLIFYING PARAMETRIC LOOP FILTERS,” which is hereby incorporated by reference.

A high-level syntax of HEVC includes (from higher level to lower level): Sequence Parameter Set (SPS), Picture Parameter Set (PPS), Slice Header and Large Coding Unit (CU) header.

In some embodiments, an additional syntax level includes an Adaptive Slice Parameter (ASP). The level is added between PPS and the Slice Header. The ALF parameters are signaled in PPS. However, if ALF parameters are moved to ASP, then the changes in the ALF section of PPS are also moved to ASP.

In some embodiments, in the SPS, 1 bit is added to signal whether the “default” or fixed ALF filters are to be updated for this sequence. If yes, then the new set of default filters are explicitly coded. In the PPS, a flag is used to determine whether to update the default filters at the picture level. If yes, filter coefficients are transmitted. In the Slice Header, a flag is added to show whether the online filter and the fixed filters are both available for block-level switching or not. Block-level filter switching is also referred to as ALF's CU control parameters. In the LCU Header, the maximum depth (minimum block-size) for the ALF's CU control parameters (block-level filter switchings) is explicitly signaled.

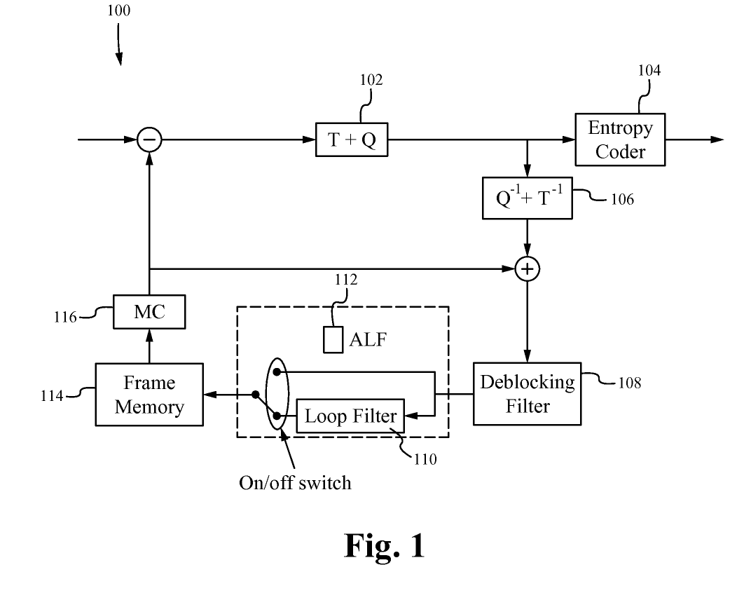

FIG. 1 illustrates a diagram of a portion of an encoder including an adaptive loop filter. The encoder 100 includes a transform and quantization component 102, an entropy coding component 104, an inverse quantization and transform component 106, a deblocking component 108, a loop filter 110, an adaptive loop filter 112, a frame memory 114 and a motion estimation component 116.

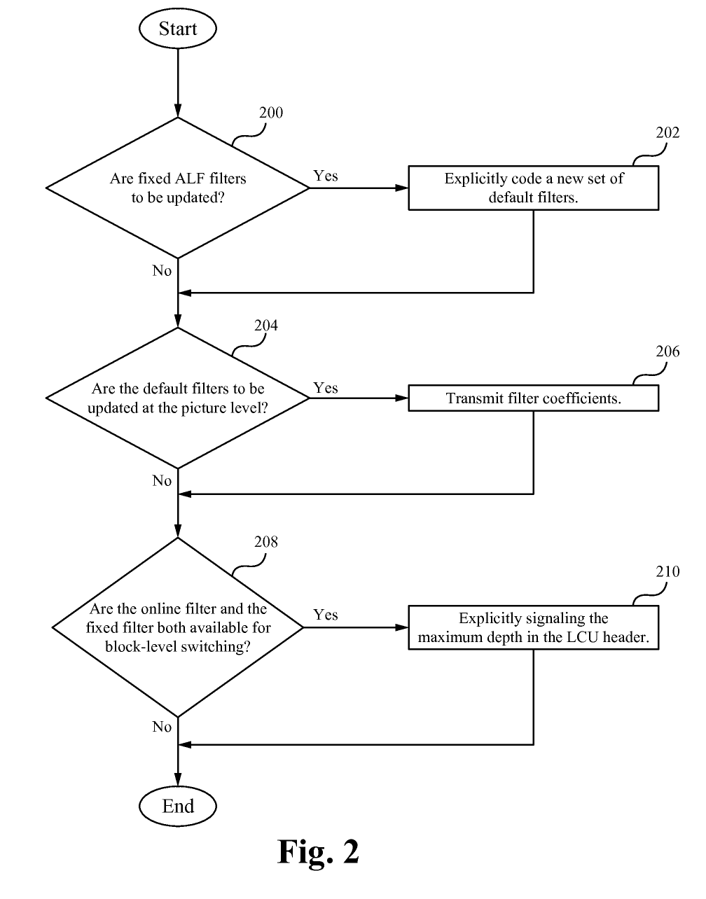

FIG. 2 illustrates a flowchart of a method of implementing a modified high-level syntax of HEVC. In the step 200, it is determined if the fixed ALF filters are to be updated. If the ALF filters are to be updated, then a new set of default filters are explicitly coded, in the step 202. If the ALF filters are not to be updated, then the process goes to the step 204. In the step 204, it is determined if the default filters are to be updated at the picture level. If the default filters are to be updated at the picture level, then filter coefficients are transmitted, in the step 206. If not, then the process goes to the step 208. In the step 208, it is determined if the online filter and the fixed filters are both available for block-level switching. If the online filter and the fixed filters are available for block-level switching, the maximum depth is explicitly signaled in the LCU header, in the step 210.

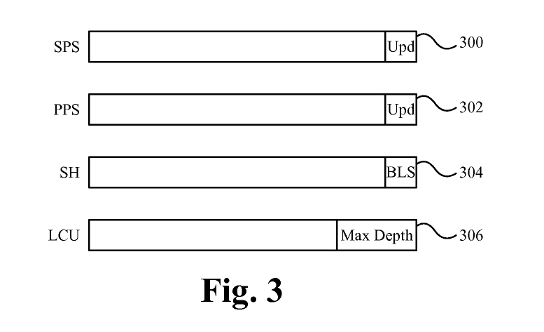

FIG. 3 illustrates a graphical representation of a modified HEVC syntax according to some embodiments. In the SPS, a 1 bit default signal 300 is added to signal whether the “default” or fixed ALF filters are to be updated for the sequence. In the PPS, a flag 302 is used to determine whether to update the default filters at the picture level. In the Slice Header, a flag 304 is added to show whether the online filter and the fixed filters are both available for block-level switching or not. In the LCU header, a maximum depth 306 for which the ALF's CU control parameters is explicitly signaled.

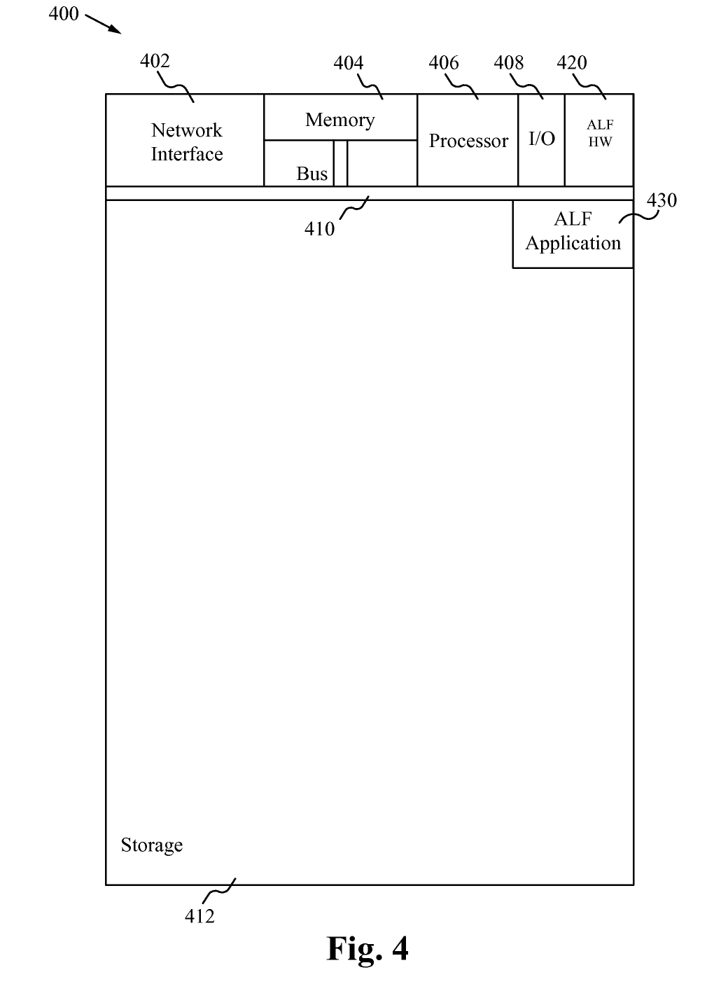

FIG. 4 illustrates a block diagram of an exemplary computing device 400 configured to implement the syntax extension of an adaptive loop filter according to some embodiments. The computing device 400 is able to be used to acquire, store, compute, process, communicate and/or display information such as images, videos and audio. For example, a computing device 400 is able to used to acquire and store an image. The syntax extension of an adaptive loop filter is typically used during or after acquiring images. In general, a hardware structure suitable for implementing the computing device 400 includes a network interface 402, a memory 404, a processor 406, I/O device(s) 408, a bus 410 and a storage device 412. The choice of processor is not critical as long as a suitable processor with sufficient speed is chosen. The memory 404 is able to be any conventional computer memory known in the art. The storage device 412 is able to include a hard drive, CDROM, CDRW, DVD, DVDRW, Blu-Ray®, flash memory card or any other storage device. The computing device 400 is able to include one or more network interfaces 402. An example of a network interface includes a network card connected to an Ethernet or other type of LAN. The I/O device(s) 408 are able to include one or more of the following: keyboard, mouse, monitor, display, printer, modem, touchscreen, button interface and other devices. In some embodiments, the hardware structure includes multiple processors and other hardware to perform parallel processing. The an adaptive loop filter application(s) 430 used to perform the syntax extension are likely to be stored in the storage device 412 and memory 404 and processed as applications are typically processed. More or less components shown in FIG. 4 are able to be included in the computing device 400. In some embodiments, adaptive loop filter hardware 420 is included. Although the computing device 400 in FIG. 4 includes applications 430 and hardware 420 for implementing the syntax extension, the adaptive loop filter method is able to be implemented on a computing device in hardware, firmware, software or any combination thereof. For example, in some embodiments, the adaptive loop filter applications 430 are programmed in a memory and executed using a processor. In another example, in some embodiments, the adaptive loop filter hardware 420 is programmed hardware logic including gates specifically designed to implement the method.

In some embodiments, the adaptive loop filter application(s) 430 include several applications and/or modules. In some embodiments, modules include one or more sub-modules as well.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television, a home entertainment system or any other suitable computing device.

To utilize the syntax extension of an adaptive loop filter, a device such as a digital camera is used to acquire a video/image. The adaptive loop filter is automatically used for improving picture quality. The adaptive loop filter is able to be implemented automatically without user involvement.

In operation, the syntax extension of an adaptive loop filter improves image quality by adding bits/flags, for example, in the sequence parameter set, a bit is added to signal whether the “default” or fixed adaptive loop filters are to be updated for this sequence, in the picture parameter set, a flag is used to determine whether to update the default filters at the picture level, in the Slice Header, a flag is added to show whether the online filter and the fixed filters are both available for block-level switching or not. Block-level filter switching is also referred to as ALF's CU control parameters. In the LCU Header, the maximum depth (minimum block-size) for the ALF's CU control parameters (block-level filter switchings) is explicitly signaled.

### Some Embodiments of Syntax Extension of Adaptive Loop Filter in HEVC

1. A method programmed in a memory of a device comprising:
a. determining if fixed filters are flagged to be updated;
b. if the fixed filters are flagged to be updated, then explicitly coding a new set of default filters;
c. determining if the default filters at a picture level are flagged to be updated;
d. if the default filters at the picture level are flagged to be updated, then transmitting filter coefficients;
e. determining if an online filter and fixed filters are flagged as both being available for block-level switching; and
f. if the online filter and fixed filters are flagged, then signaling a maximum depth in a largest coding unit header.

2. The method of clause 1 wherein the method is implemented as part of an adaptive loop filter process.

3. The method of clause 1 wherein the method is implemented within a high efficiency video coding syntax.

4. The method of clause 1 wherein the device selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

5. An apparatus comprising:
a. a memory for storing a data structure, the data structure including:
   i. a sequence parameter set with a default signal bit for signaling whether fixed adaptive loop filters are to be updated for a sequence;
   ii. a slice header with a block-level flag to indicate whether an online filter and the fixed filters are both available for block-level switching; and
   iii. a large coding unit header for signaling a maximum depth for the fixed filters coding unit control parameters; and
b. a processing component coupled to the memory, the processing component configured for processing the application.

6. The apparatus of clause 5 wherein if the default signal bit is true, then a new set of default filters are explicitly coded.

7. The apparatus of clause 5 wherein the data structure further comprises a picture parameter set with an update flag to determine whether to update the fixed filters at a picture level.

8. The apparatus of clause 7 wherein if the update flag is true, then filter coefficients are transmitted.

9. The apparatus of clause 5 wherein the data structure further comprises an adaptive slice parameter.

10. The apparatus of clause 9 wherein the adaptive slice parameter is used to determine whether to update the fixed filters at a picture level.

11. The apparatus of clause 5 wherein the apparatus is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

12. An encoder comprising:
a. a transform and quantization component for applying a transform and quantization to a video;
b. an inverse quantization and transform component for applying an inverse transform and quantization to the video;
c. a deblocking filter for smoothing edges within the video;
d. an adaptive loop filter with a syntax extension for filtering the video; and
e. an entropy coder for encoding the video.

13. The encoder of clause 12 wherein the adaptive loop filter further comprises a sequence parameter set with a default signal bit for signaling whether fixed adaptive loop filters are to be updated for a sequence.

14. The encoder of clause 13 wherein if the default signal bit is true, then a new set of default filters are explicitly coded.

15. The encoder of clause 13 wherein the adaptive loop filter further comprises a picture parameter set with an update flag to determine whether to update the fixed filters at a picture level.

16. The encoder of clause 15 wherein if the update flag is true, then filter coefficients are transmitted.

17. The encoder of clause 15 wherein the adaptive loop filter further comprises a slice header with a block-level flag to indicate whether an online filter and the fixed filters are both available for block-level switching.

18. The encoder of clause 17 wherein the adaptive loop filter further comprises a large coding unit header for signaling a maximum depth for the fixed filters coding unit control parameters.

19. The encoder of clause 12 wherein the adaptive loop filter further comprises an adaptive slice parameter.

20. The encoder of clause 19 wherein the adaptive slice parameter is used to determine whether to update the fixed filters at a picture level.

21. The encoder of clause 12 wherein the encoder is implemented in a digital camera or a digital camcorder.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a memory of a device comprising:
a. determining if fixed filters are flagged to be updated;
b. if the fixed filters are flagged to be updated, then explicitly coding a new set of default filters;
c. determining if the default filters at a picture level are flagged to be updated;
d. if the default filters at the picture level are flagged to be updated, then transmitting filter coefficients;
e. determining if an online filter and fixed filters are flagged as both being available for block-level switching; and
f. if the online filter and fixed filters are flagged, then signaling a maximum depth in a largest coding unit header.

2. The method of claim 1 wherein the method is implemented as part of an adaptive loop filter process.

3. The method of claim 1 wherein the method is implemented within a high efficiency video coding syntax.

4. The method of claim 1 wherein the device selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

5. An apparatus comprising:
a. a memory for storing a data structure, the data structure including:
i. a sequence parameter set with a default signal bit for signaling whether fixed adaptive loop filters are to be updated for a sequence;
ii. a slice header with a block-level flag to indicate whether an online filter and the fixed filters are both available for block-level switching; and
iii. a large coding unit header for signaling a maximum depth for the fixed filters coding unit control parameters; and
b. a processing component coupled to the memory, the processing component configured for processing the application.

6. The apparatus of claim 5 wherein if the default signal bit is true, then a new set of default filters are explicitly coded.

7. The apparatus of claim 5 wherein the data structure further comprises a picture parameter set with an update flag to determine whether to update the fixed filters at a picture level.

8. The apparatus of claim 7 wherein if the update flag is true, then filter coefficients are transmitted.

9. The apparatus of claim 5 wherein the data structure further comprises an adaptive slice parameter.

10. The apparatus of claim 9 wherein the adaptive slice parameter is used to determine whether to update the fixed filters at a picture level.

11. The apparatus of claim 5 wherein the apparatus is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

12. An encoder comprising:
a. a transform and quantization component for applying a transform and quantization to a video;
b. an inverse quantization and transform component for applying an inverse transform and quantization to the video;
c. a deblocking filter for smoothing edges within the video;
d. an adaptive loop filter with a syntax extension for filtering the video; and
e. an entropy coder for encoding the video.

13. The encoder of claim 12 wherein the adaptive loop filter further comprises a sequence parameter set with a default signal bit for signaling whether fixed adaptive loop filters are to be updated for a sequence.

14. The encoder of claim 13 wherein if the default signal bit is true, then a new set of default filters are explicitly coded.

15. The encoder of claim 13 wherein the adaptive loop filter further comprises a picture parameter set with an update flag to determine whether to update the fixed filters at a picture level.

16. The encoder of claim 15 wherein if the update flag is true, then filter coefficients are transmitted.

17. The encoder of claim 15 wherein the adaptive loop filter further comprises a slice header with a block-level flag to indicate whether an online filter and the fixed filters are both available for block-level switching.

18. The encoder of claim 17 wherein the adaptive loop filter further comprises a large coding unit header for signaling a maximum depth for the fixed filters coding unit control parameters.

19. The encoder of claim 12 wherein the adaptive loop filter further comprises an adaptive slice parameter.

20. The encoder of claim 19 wherein the adaptive slice parameter is used to determine whether to update the fixed filters at a picture level.

21. The encoder of claim 12 wherein the encoder is implemented in a digital camera or a digital camcorder.
